(19) United States
(12) Patent Application Publication
(10) Pub. No.: US 2016/0131096 A1
(43) Pub. Date: May 12, 2016

(54) FILTER FOR FLUID SUPPLY SYSTEM

(71) Applicant: Caterpillar Inc., Peoria, IL (US)

(72) Inventors: Mark T. Allott, Mapleton, IL (US); Bryant A. Morris, Peoria, IL (US)

(73) Assignee: Caterpillar Inc., Peoria, IL (US)

(21) Appl. No.: 14/979,622

(22) Filed: Dec. 28, 2015

(51) Int. Cl. F02M 37/22; B01D 35/30; B01D 27/08; B01D 35/00

(52) U.S. Cl. CPC F02M 37/22; B01D 35/005; B01D 35/30; B01D 27/08

(57) ABSTRACT

A filter includes housing and a filter device disposed within the housing to define a circumferential cavity therebetween. The filter further includes a cap coupled to an inlet port and the cap includes a first thread portion. The filter further includes a first seal member attached to a first end of the filter device to restrict entry of fluid from the circumferential cavity into a hollow center tube disposed within the filter device. The filter further includes an engagement member provided on the first seal member and the engagement portion includes a second thread portion. The first thread portion of cap is adapted to engage with the second thread portion of the engagement member for removing filter device from the housing. Further, a second seal member is attached to a second end of the filter device to restrict flow of the fluid from the circumferential cavity into a drain port.

### TECHNICAL FIELD

The present disclosure relates to a fluid supply system and more particularly to a filter for the fluid supply system.

### BACKGROUND

Generally, a fluid supply system of an engine is equipped with a filter to eliminate contaminants from fluids flowing through the fluid supply system. The filters are equipped with replaceable filter device. Generally, the filter device is removable or detachable, so that the filter device can be replaced by a new filter. Conventionally, replacing the filter device requires a skilled operator to grasp the filter device using their bare hands, which would pose an ergonomic risk of exposing operator's hand to hazardous fluid. In addition, while removing the filter device from the fluid filter, fluid may flow into downstream components, thereby increasing probability of catastrophic failure of the downstream components.

US Patent Publication Number 2014/0027366, hereinafter referred to as the '366 application, describes a cartridge top load filter design and filter element useable with the filter. The cartridge and the filter element allow fluid to be drained from filter housing, from exterior of the filter housing and without first removing a filter element or a cover of the filter housing. The draining feature is manually activated by a knob that is accessible from the exterior of the filter housing adjacent to the removable cover. The '366 application discloses a cover of the filter element that is threaded to an internal surface of a housing of the cartridge top load filter. Since the contaminated fluid is received in a cavity defined between the filter element and the housing, the contaminants in the fluid may get deposited in the threads, thereby requiring extra effort to be applied by the operator while replacing the filter element.

### SUMMARY OF THE DISCLOSURE

According to an aspect of the present disclosure, a filter for a fluid supply system is provided. The filter includes a housing having an inner surface and an outer surface. The housing further includes an inlet port to receive fluid into the housing and a drain port to drain the fluid from the housing. The filter further includes a cap detachably coupled to the inlet port. The cap includes a first thread portion. The filter further includes a filter device having an inner surface and an outer surface. The filter device is disposed within the housing to define a circumferential cavity between the outer surface of the filter device and the inner surface of the housing. The circumferential cavity is in fluid communication with the inlet port of the housing to receive the fluid into the circumferential cavity from the fluid supply system. The filter further includes a hollow center tube disposed within the filter device. The hollow center tube includes a first end and a second end, the first end being fastened to the inner surface of the housing and adapted to supply the fluid to one or more downstream components of the fluid supply system. The filter further includes a first seal member attached to a first end of the filter device, the first seal member adapted to restrict entry of the fluid from the cavity into the hollow center tube via the first end of the filter device. The filter further includes an engagement member provided on the first seal member. The engagement member extends in a direction perpendicular to a surface of the first seal member and away from the first end of the filter device. The engagement member includes a second thread portion. The filter further includes second seal member attached to a second end of the filter device. The second seal member includes a first annular ring extending in a direction perpendicular to a surface of the second seal member and disposed distal from the hollow center tube. The first annular ring restricts flow of the fluid from the cavity into the drain port in an engaged condition of the filter device. The second seal member further includes a second annular ring extending in a direction perpendicular to the surface of the second seal member and proximal to the hollow center tube. The second annular ring restricts flow of the fluid from the hollow center tube into the drain port in the engaged condition of the filter device. The first thread portion of the cap engages with the second thread portion of the engagement member for removing the filter device from the housing.

Other features and aspects of this disclosure will be apparent from the following description and the accompanying drawings.

### BRIEF DESCRIPTION OF THE DRAWINGS

FIG. 1 is a block diagram of a fluid supply system having a filter, according to an embodiment of the present disclosure;

FIG. 2 is a cross-sectional view of a filter in an engaged condition;

FIG. 3 is an enlarged view of an encircled portion 3-3 in FIG. 2;

FIG. 4 is a cross-sectional view of the filter in a disengaged condition; and

FIG. 5 is an enlarged view of an encircled portion 5-5 in FIG. 4.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

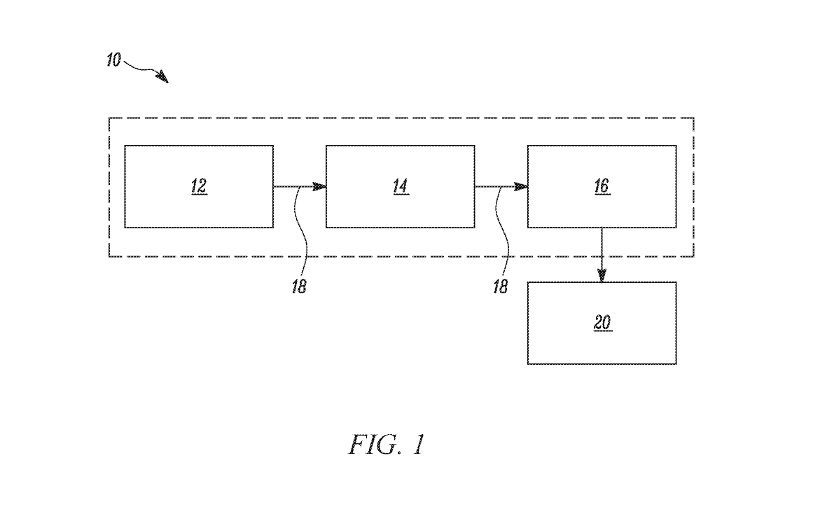

FIG. 1 illustrates a schematic block diagram of a fluid supply system 10. The fluid supply system 10 includes a fluid tank 12, a fluid pump 14, and a filter 16 connected via fluid flow lines 18. The fluid pump 14 may supply fluid, such as lubrication oil, from the fluid tank 12 to the filter 16. The filter 16 may be one of several components within the fluid supply system 10 and is adapted to receive the fluid either from the fluid pump 14 or from one or more upstream components of the fluid supply system 10. In an example, the filter 16 may be a lube filter, a fuel filter, a hydraulic fluid filter, a coolant filter, or any other filter that facilitates filtering of the fluid. Particles suspended within the fluid are filtered and subsequently supplied to downstream systems 20. In an example, the downstream systems 20 may include, but is not limited to, engine, auxiliary gearbox, and transmission system. Further the filter 16 may be oriented in a top-load configuration. The top-load configuration allows servicing or access to the filter 16 from a position above the filter 16.

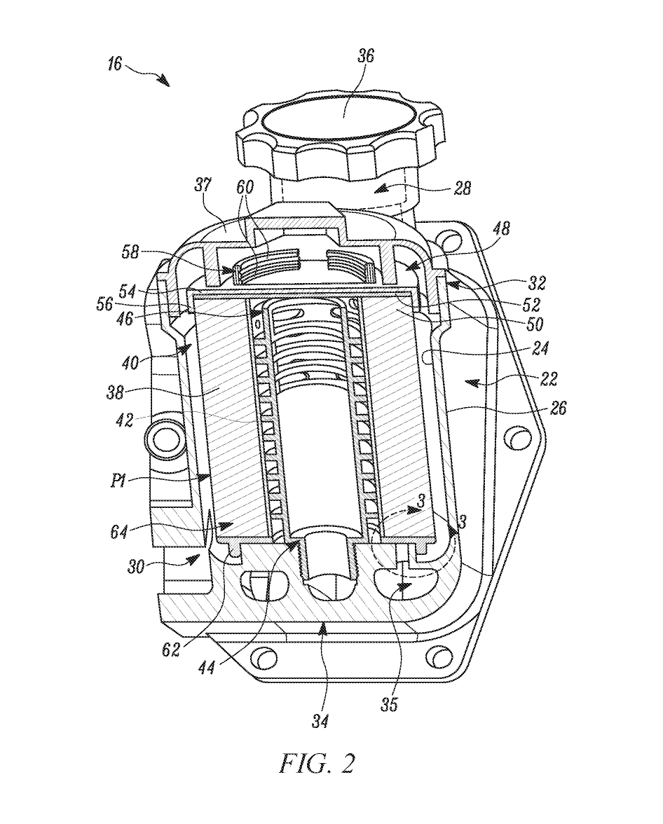

FIG. 2 illustrates a cross-sectional view of the filter 16. The filter 16 includes a housing 22 having an inner surface 24 and an outer surface 26. The inner surface 24 and the outer surface 26 define a thickness (not shown) of the housing 22. The housing 22 shown in FIG. 2 has a circular cross-section. However, in an example, cross-section of the housing 22 may be a square, a rectangle, a polygon, or an ellipse. The housing 22 may be mounted or coupled at a location in the fluid supply system 10 to perform the function of filtering fluid. The housing 22 further includes an inlet port 28 for supplying fluid into the housing 22. Alternatively, the fluid can also be supplied into the housing 22 via an auxiliary port 30 provided in the housing 22. The housing 22 also includes a head portion 32 and a base portion 34. In addition, the housing 22 includes a drain port 35 at the base portion 34 to drain the fluid from the housing 22.

The filter 16 further includes a cap 36 coupled to the inlet port 28 of the housing 22. The cap 36 shown in FIG. 2 has a circular cross-section. However, it will be understood that the cap 36 may be provided with various other cross-sectional profiles, such that the cap 36 can be coupled to the inlet port 28. The cap 36 is threadably coupled to a periphery of the inlet port 28. However, it will be understood that a snap fit arrangement may be provided between the cap 36 and the periphery of the inlet port 28 to facilitate easy coupling and detachment of the cap 36 to and from the inlet port 28, respectively.

The filter 16 further includes a cover member 37 coupled to the housing 22. Specifically, the cover member 37 is coupled to the head portion 32 of the housing 22 in a manner, such that the cover member 37 can be detached from the housing 22 when required. The cover member 37 shown in FIG. 2 has a circular cross-section. However, it will be understood that the cover member 37 may be provided with various other cross-sections, such that the cover member 37 can be coupled to the head portion 32 of the housing 22. In addition, the cover member 37 also provides access to components housed within the housing 22, when the cover member 37 is detached from the housing 22. In one example, the cover member 37 may be threadably coupled to the housing 22. In another example, a snap fit arrangement may be provided between the cover member 37 and the housing 22 to facilitate easy coupling and detachment of the cover member 37 to and from the housing 22, respectively.

The filter 16 further includes a filter device 38 disposed coaxially within the housing 22. The filter device 38 shown in FIG. 2 has a circular cross-section. However, it will be understood that the cross-section of the filter device 38 may be one of a square, a rectangle, a polygon, or an ellipse. The cross-section of the filter device 38 may be defined based on the cross-section of the housing 22. In such an arrangement, the filter device 38 defines a circumferential cavity 40 between an outer surface 74 of the filter device 38 and the inner surface 24 of the housing 22. The circumferential cavity 40 is in fluid communication with the inlet port 28 of the housing 22 to receive the fluid into the circumferential cavity 40 from the fluid supply system 10.

The filter 16 further includes a hollow center tube 42 disposed within the filter device 38. In one example, the hollow center tube 42 may be coaxially disposed within the filter device 38. The hollow center tube 42 has a first end 44 and a second end 46. The first end 44 of the hollow center tube 42 is attached to the base portion 34 of the housing 22 and the second end 46 of the hollow center tube 42 is disposed distal from the base portion 34 and in a direction towards the cap 36. The first end 44 of the hollow center tube 42 is attached to the base portion 34 of the housing 22 as shown in FIG. 2. The hollow center tube 42 is adapted to supply filtered fluid to the downstream systems 20.

The filter 16 further includes a first seal member 48 attached to a first end 50 of the filter device 38. In one example, the first seal member 48 may be made from plastic, polyurethane, or resin impregnated materials. The first seal member 48 may either be a single plate like structure or may be composed of one or more layers. For instance, as shown in FIG. 2, the first seal member 48 includes a sealing layer 52 and a covering layer 54. The sealing layer 52 is attached to the first end 50 of the filter device 38 to seal the first end 50 and the covering layer 54 is disposed on top of the sealing layer 52 to cover the sealing layer 52. For the purpose of covering the sealing layer 52, the covering layer 54 includes a protrusion 56 that extends in a direction perpendicular to a surface of the covering layer 54, along a periphery of the covering layer 54, and towards the filter device 38. The protrusion 56 aids in enclosing the sealing layer 52.

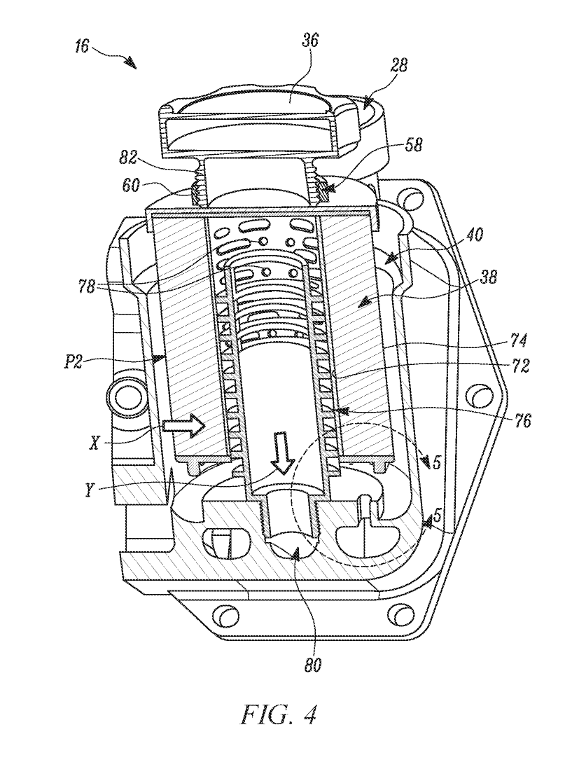

The filter 16 further includes an engagement member 58 provided on the first seal member 48 to engage with a first thread portion 82 (shown in FIG. 4) of the cap 36. For the purpose of engaging, the engagement member 58 includes a second thread portion 60. The engagement member 58 extends in a direction perpendicular to the surface of the covering layer 54 and away from the first end 50 of the filter device 38. In addition, the engagement member 58 is provided as an arcuate protrusion on the first seal member 48, where an inner diameter of the arcuate protrusions is greater than an outer diameter of the cap 36 to receive the cap 36 coaxially therein. In an example, an outer diameter of the arcuate protrusion may be lesser than an inner diameter of the cap 36 to receive the cap 36 coaxially thereon. However, it will be appreciated that the manner of engagement described herein does not limit the present disclosure. Alternatively, the cap 36 may be engaged with the engagement member 58 by a snap fit arrangement. The cover member 37 covers the engagement member 58 and prevents any damage to the engagement member 58.

Further, the filter 16 includes a second seal member 62 attached to a second end 64 of the filter device 38. In one example, the second seal member 62 may be made from plastic, polyurethane, or resin impregnated materials. As such, the first seal member 48 and the second seal member 62 aids in packaging the filter device 38 within the housing 22.

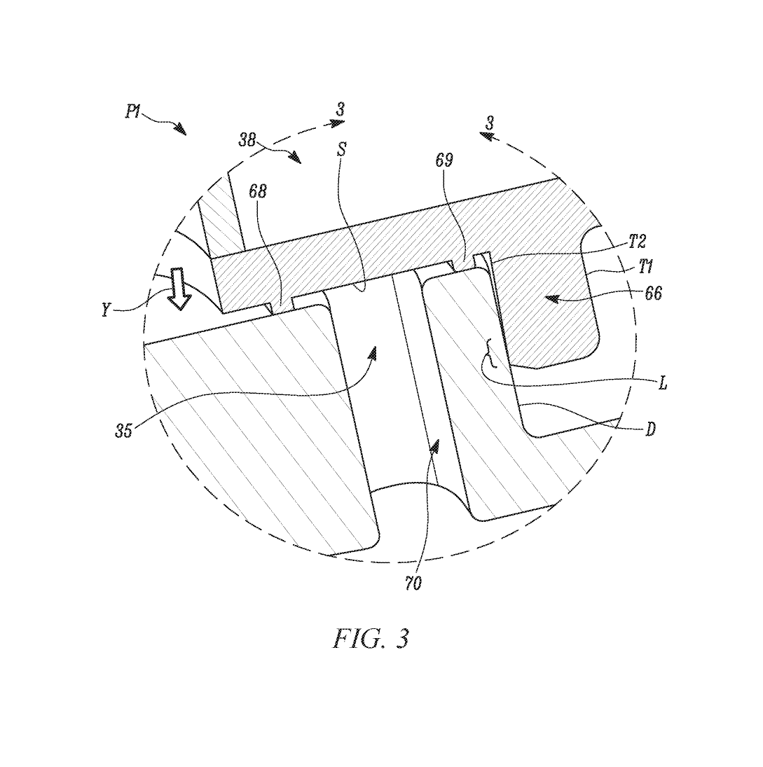

FIG. 3 illustrates an enlarged view of an encircled portion 3-3 in FIG. 2. In particular, the enlarged view of the encircled portion 3-3 illustrates the second seal member 62 and an engaged position “P1” of the filter device 38. The second seal member 62 includes a first annular ring 66 that extends in a direction perpendicular to a surface “S” of the second seal member 62 and away from the filter device 38. The first annular ring 66 is formed as an integral part of the second seal member 62. Further, since the second seal member 62 is shown as a circular plate like structure, the first annular ring 66 is formed as a circular protrusion on the surface “S” of the second seal member 62. However, based on the cross-section of the base portion 34, the first annular ring 66 may be provided with a corresponding protrusion to seal a periphery of the drain port 35.

As illustrated in FIG. 3, the first annular ring 66 is shown to have a trapezoidal cross-section. In other words, a first side “T1” is non-parallel to a second side “T2” of the first annular ring 66. Additionally, the second side “T2” is inclined with respect to a surface “D” of the drain port 35. With such construction, only a predetermined length “L” of the second side “T2” abuts the surface “D” of the drain port 35. As such, the filter device 38 is pushed in a downward direction “Y” to engage the filter device 38 with the base portion 34 of the housing 22. The predetermined length “L” of the second side “T2” forms a seal between the circumferential cavity 40 and the drain port 35.

Such sealing of the first annular ring 66 restricts flow of fluid from the circumferential cavity 40 into the drain port 35 in the engaged position “P1” of the filter device 38. Therefore, with reference to the above description, engaged position “P1” will be understood as a position of the filter device 38 in which the predetermined length “L” of the second side “T2” abuts the surface “D” of the drain port 35 to provide the sealing between the second side “T2” and the surface “D”.

The second seal member 62 further includes a second annular ring 68 extending in the downward direction “Y” from the surface “S” of the second seal member 62, similar to the first annular ring 66. The second annular ring 68 is located proximal with respect to the hollow center tube 42 and the first annular ring 66 is positioned distal with respect to the hollow center tube 42. As such, the second annular ring 68 is provided as a concentric rectangular cross-sectional protrusion on the second seal member 62. In the engaged position “P1” of the filter device 38, the second annular ring 68 restricts flow of fluid, which is filtered fluid, from the hollow center tube 42 to the drain port 35, thereby eliminating any loss of fluid during the filtration process. Based on a height of a peripheral wall 70, length of the second annular ring 68 may be determined, as it would be understood by a person skilled in the art in conjunction with FIG. 3. In addition, the second seal member 62 includes a third annular ring 69 that is similar to the second annular ring 68. The third annular ring 69 provides additional sealing between the first annular ring 66 and the drain port 35.

FIG. 4 illustrates a cross-sectional view of the filter device 38 in a disengaged position “P2”. The filter device 38 includes an inner surface 72 and an outer surface 74. The inner surface 72 may be understood as an inner peripheral surface proximal with respect to the hollow center tube 42 and the outer surface 74 may be understood as an outer peripheral surface distal with respect to the hollow center tube 42. Further, the filter device 38 is surrounded by the first seal member 48, the second seal member 62, and an inner lining member 76. The inner lining member 76 is secured to the inner surface 72 of the filter device 38. With such an arrangement, the first seal member 48, the second seal member 62, and the inner lining member 76 provides strength and packaging to the filter device 38. As such, the filter device 38 may be obtained as a single component along with the first seal member 48, the second seal member 62, and the inner lining member 76 attached at the respective locations on the filter device 38. In order to allow the filtered fluid to enter the hollow center tube 42, the inner lining member 76 includes multiple apertures 78. As such, the fluid entering the filter device 38 from the circumferential cavity 40 in an inward direction “X” gets filtered and thereafter passes through the apertures 78 to enter the hollow center tube 42. Subsequently, the filtered fluid flows in the downward direction “Y” and is supplied to the downstream systems 20 through a supply port 80.

In order to disengage the filter device 38 from the housing 22, initially, the cover member 37 is disengaged from the housing 22. Subsequently, the cap 36 is disengaged from the inlet port 28 and engaged with the engagement member 58. During such engagement, the first thread portion 82 of the cap 36 engages with the second thread portion 60 of the engagement member 58. As such, the cap 36 and the filter device 38 form a sub-assembly. In order to disengage the filter device 38 for replacement, an operator can grab the cap 36 and pull the sub-assembly in a direction outward with respect to the housing 22, to disengage the filter device 38 from the housing 22 Likewise, continued effort by the operator can facilitate removal of the filter device 38 from the housing 22.

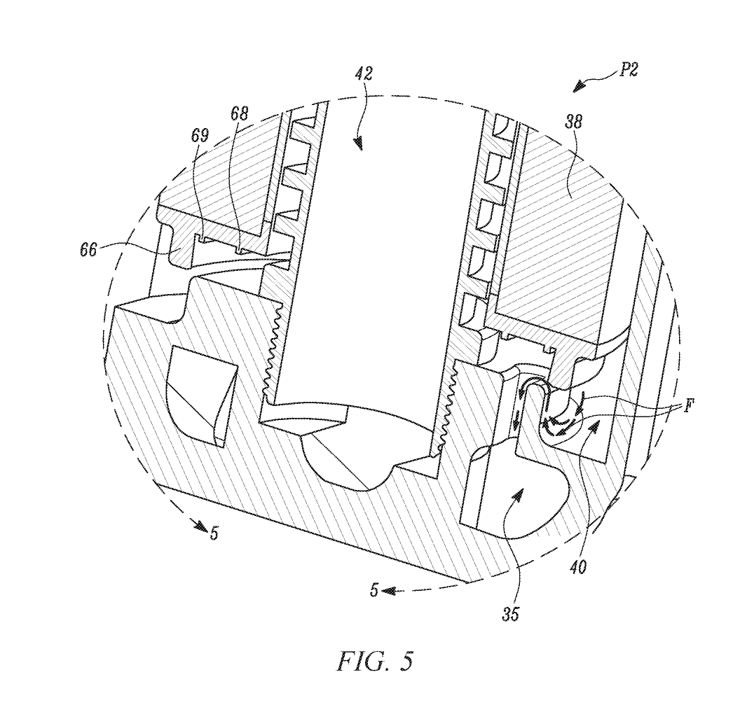

FIG. 5 illustrates an enlarged view of an encircled portion 5-5 in FIG. 4. For the purpose of convenience, the encircled portion 5-5 is illustrated as a perspective view of a bottom portion of the filter device 38 in the disengaged position “P2” of the filter device 38. As the sub-assembly is moved in the direction outward with respect to the housing 22, the filter device 38 moves from the engaged position “P1” to the disengaged position “P2”. In the disengaged position “P2”, the fluid present in the circumferential cavity 40 is allowed to flow in a flow path “F”, as shown in FIG. 5. Subsequently, the fluid is drained out of the housing 22. In addition, the fluid present between the inner lining member 76 and the hollow center tube 42 is also allowed to flow down and drain through the drain port 35.

### INDUSTRIAL APPLICABILITY

The present disclosure describes the filter 16. Owing to the presence of the first thread portion 82 provided on the cap 36 and the second thread portion 60 provided on the engagement member 58, the cap 36 can be easily engaged with the filter device 38 to form the sub-assembly. Subsequently, the sub-assembly can be pulled in the direction outward with respect to the housing 22 of the filter 16 to disengage the filter device 38 from the housing 22. Accordingly, the filter device 38 may be removed out of the housing 22 for the purpose of replacement. With such arrangement and construction of the filter 16, the operator may be able to replace the filter device 38 with minimum efforts. In additional, since the cap 36 aids in removal of the filter device 38 from the housing 22, the operator's hand is free from the fluid present in the circumferential cavity 40. As such, any ergonomic risk of exposing operator's hand to hazardous materials or fluid, such as unfiltered oil, is overcome by the present disclosure.

Additionally, the drain port 35, the first annular ring 66, and the second annular ring 68, facilitate smooth draining of the fluid present in the circumferential cavity 40, during the removal of the filter device 38 from the housing 22. As such, any fluid present in the circumferential cavity 40 is drained, thereby reducing amount of fluid which would partially remain in the filter device 38 during the removal of the filter device 38. Furthermore, such draining of the fluid through the drain port 35 also prevents contamination of environment around the filter 16 after the filter device 38 is removed from the housing 22.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments can be understood to fall within the scope of the present disclosure as determined based upon the claims and any equivalents thereof.

What is claimed is:

1. A filter for a fluid supply system, the filter comprising:
a housing having an inner surface and an outer surface, the housing including:
an inlet port adapted to receive fluid into the housing; and
a drain port adapted to drain the fluid from the housing;
a cap detachably coupled to the inlet port, the cap including a first thread portion;
a filter device having an inner surface and an outer surface, the filter device disposed within the housing to define a circumferential cavity between the outer surface of the filter device and the inner surface of the housing, the circumferential cavity being in fluid communication with the inlet port of the housing to receive the fluid into the circumferential cavity from the fluid supply system;
a hollow center tube disposed within the filter device, the hollow center tube includes a first end and a second end, the first end being fastened to a base portion of the housing and adapted to supply the fluid to one or more downstream components of the fluid supply system;
a first seal member attached to a first end of the filter device, the first seal member adapted to restrict entry of the fluid from the circumferential cavity into the hollow center tube via the first end of the filter device;
an engagement member provided on the first seal member, the engagement member extending in a direction perpendicular to a surface of the first seal member and away from the first end of the filter device, wherein the engagement member includes a second thread portion; and
a second seal member attached to a second end of the filter device, the second seal member includes:
a first annular ring extending in a direction perpendicular to a surface of the second seal member and disposed distal from the hollow center tube, wherein the first annular ring restrict flow of the fluid from the circumferential cavity into the drain port in an engaged position portion of the filter device; and
a second annular ring extending in a direction perpendicular to the surface of the second seal member and proximal to the hollow center tube, wherein the second annular ring restrict flow of the fluid from the hollow center tube into the drain port in the engaged position of the filter device,
wherein the first thread portion of the cap engages with the second thread portion of the engagement member for removing the filter device from the housing.
